(19) United States
(12) Patent Application Publication
(10) Pub. No.: US 2026/0131917 A1
(43) Pub. Date: May 14, 2026

(54) AIRCRAFT WITH WIND POWER GENERATION FUNCTION AND LANDING PAD THEREOF

(71) Applicant: KOREA AEROSPACE RESEARCH INSTITUTE, Daejeon (KR)

(72) Inventor: Sung Ho CHANG, Daejeon (KR)

(21) Appl. No.: 19/379,478

(22) Filed: Nov. 4, 2025

(30) Foreign Application Priority Data
Nov. 8, 2024 (KR) 10-2024-0157918

(51) Int. Cl. B64U 50/37; B64U 10/20; B64U 20/80; B64U 30/293; B64U 30/297; B64U 40/10; B64U 50/19; B64U 50/23; B64U 70/99; F03D 9/11; F03D 9/32

(52) U.S. Cl. CPC B64U 50/37; B64U 10/20; B64U 20/80; B64U 30/293; B64U 30/297; B64U 40/10; B64U 50/19; B64U 50/23; B64U 70/99; F03D 9/11; F03D 9/32; F05B 2220/706

(57) ABSTRACT

The present disclosure relates to an aircraft having a wind power generation function and a landing pad thereof. In an embodiment, the aircraft includes a nacelle to which a rotor is mounted, a rotator connected to the rotor and capable of converting rotational energy of the rotor into electrical energy, and a power generation module that charges a battery with the electrical energy of the rotor, wherein the rotor may freely rotate by wind power when the aircraft is not flying.

### CROSS-REFERENCE TO RELATED APPLICATION

This application is based on and claims priority under 35 U.S.C. § 119 to Korean Patent Application No. 10-2024-0157918, filed on Nov. 8, 2024, in the Korean Intellectual Property Office, the disclosure of which is incorporated by reference herein in its entirety.

### BACKGROUND

### 1. Field

The disclosure relates to an aircraft capable of generating wind power on its own and a landing pad for an aircraft having a wind power generation function.

### 2. Description of the Related Art

Battery-powered aircraft (e.g., unmanned aerial vehicles) may be manufactured in various sizes and shapes, and are utilized in a variety of fields such as military applications, facility and environmental inspections, and disaster relief.

In particular, eco-friendly energy facilities (e.g., wind power generation, solar power generation, etc.) are often installed in environments that are difficult for humans to access or manage, such as large areas, offshore locations, or high-altitude areas, for economic reasons. Therefore, unmanned aerial vehicles, such as drones, may be utilized for monitoring such eco-friendly energy facilities.

However, in the case of battery-powered aircraft, the flight duration is limited and the flight speed is low. Therefore, time and space constraints occur when monitoring a wide area. Furthermore, a method of collecting the aircraft for recharging and manually replacing the batteries is unsuitable for inspecting offshore wind farms and solar farms that are difficult to access. Furthermore, charging the aircraft's batteries using separate charging equipment requires additional charging equipment and facilities.

### SUMMARY

Provided are an aircraft and a landing pad that do not require separate charging devices or facilities.

Also, provided is an aircraft that does not require battery replacement by an operator.

In addition, provided is an aircraft capable of self-power generation using wind power.

The problems to be solved by the technical spirit of the present disclosure are not limited to the problems mentioned above, and other problems not mentioned will be clearly understood by those skilled in the art from the following description.

Additional aspects will be set forth in part in the description which follows and, in part, will be apparent from the description, or may be learned by practice of the presented embodiments of the disclosure.

According to an aspect of the disclosure, an aircraft having a wind power generation function, the aircraft includes a nacelle to which a rotor is mounted, a rotator connected to the rotor and configured to rotate together with the rotor and convert rotational energy of the rotor into electrical energy, and a power generation module configured to charge a battery using the electrical energy generated by the rotator, wherein the rotor is configured to freely rotate by wind power when the aircraft is not in flight.

The aircraft may further include a drive module configured to supply power from the battery to the rotator, wherein the drive module may be configured to drive the rotor by supplying power from the battery to the rotator during a flight state of the aircraft.

The aircraft may further include a relay element and a controller configured to control the relay element, wherein a contact point A of the relay element may be connected to the driving module, and a contact point B of the relay element may be connected to the power generation module, and the controller may further be configured to control the relay element to connect to the contact point A when the aircraft is not in flight, and to connect to the contact point B when the aircraft is in flight.

when the relay element is connected to the contact point A, the power generation module may convert the rotational energy of the rotator by free rotation of the rotor into electrical energy to charge the battery.

The rotor may include a hub, a plurality of blades hinge-connected to the hub, and a pitch actuator configured to adjust a pitch angle of the blades, and the nacelle may be configured to be tiltable with respect to the aircraft and may include a tilt actuator for tilting the nacelle.

The aircraft may further include a controller configured to control the tilt actuator and the pitch actuator, wherein the controller may include a setting unit configured to set a target tilt angle of the nacelle and a target pitch angle of the blade, and an output unit configured to output a first control signal for controlling the operation of the tilt actuator to control the tilt angle of the nacelle to the target tilt angle and a second control signal for controlling the operation of the pitch actuator to control the pitch angle of the blade to the target pitch angle.

The aircraft may further include an RPM meter configured to measure an RPM of the rotor, wherein the setting unit may further be configured to increase the target pitch angle or the target tilt angle when the measured value of the rpm meter is greater than or equal to a reference value.

When the measured value of the rpm meter is greater than or equal to the reference value, the setting unit may further be configured to increase the target pitch angle until the measured value of the rpm meter becomes less than the reference value.

The setting unit may further be configured to increase the target pitch angle to a preset maximum pitch angle, and the setting unit may increase the target tilt angle when the measured value of the rpm meter is greater than the reference value even when the target pitch angle increases up to the maximum pitch angle.

The setting unit may further be configured to set the target pitch angle and the target tilt angle according to a pre-stored data map, wherein the data map may include data on the target pitch angle and the target tilt angle corresponding to a current wind speed.

The power generation module may include a power generation motor, the driving module includes a flight motor, and the aircraft may further include a switching module that mechanically connects the rotator to either the power generation motor or the flight motor.

The switching module may include a gearbox and an actuator, wherein the gearbox may include a first gear fitted on the rotational axis of the rotator, a second gear fitted on the rotational axis of the power generation motor, and a third gear fitted on the rotational axis of the flight motor, the rotational axis of the rotator may be configured to have a variable length, and the actuator may be configured to vary a length of the rotational axis of the rotator so that the first gear and the second gear mesh with each other, or the first gear and the third gear mesh with each other.

The switching module may include a gearbox, an actuator, and a clutch connected to the power generation motor, the gearbox includes a first gear fitted on the rotational axis of the rotor and a second gear fitted on the rotational axis of the power generation motor, the actuator may be configured to move the second gear to engage or disengage the first gear and the second gear, and the clutch may transmit or block power of the flight motor to the rotor.

According to an aspect of the disclosure, a landing pad for landing the aircraft described above includes a base and a rotating landing plate rotatable with respect to the base and configured to accommodate the aircraft, wherein the rotating landing plate may further be configured to freely rotate according to a wind direction.

The landing pad may further include a bearing between the base and the rotating landing plate.

The landing pad may further include a servo motor and a fixing mechanism for fixing the aircraft to the rotating landing plate, wherein the fixing mechanism may fix at least a portion of the aircraft to the rotating landing plate according to an operation of the servo motor.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of a landing pad and an aircraft according to an embodiment;

FIG. 2 is a rotor of an aircraft and a circuit diagram thereof;

FIGS. 3A through 3C illustrate how a tilt angle of an aircraft is adjusted;

FIGS. 4A through 4D illustrate how a pitch angle of blades is adjusted;

FIG. 5 is a block diagram of a controller according to an embodiment;

FIGS. 6A through 6C are graphs illustrating a relationship between a wind speed and a tilt angle and a relationship between generated power according to the tilt angle and a pitch angle;

FIG. 7 is a flowchart illustrating a method of adjusting a pitch angle and a tilt angle;

FIGS. 8A through 9D illustrate examples of pre-stored data maps;

FIGS. 10 and 11 are block diagrams illustrating a structure of an aircraft according to an embodiment;

FIG. 12 illustrates an example in which a plurality of landing pads are installed on a wind power generator;

FIGS. 13A and 13B are schematic diagrams of a landing pad;

FIG. 14 illustrates a landing pad according to another embodiment; and

FIG. 15 illustrates a state in which a protective cover is fixed at a specific angle.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, the disclosure will be described in detail with reference to the accompanying drawings. However, this is merely an example and the disclosure is not limited to the specific embodiments described by way of example.

The disclosure relates to an aircraft having wind power generation function and a landing pad thereof. The aircraft may be an unmanned aerial vehicle (UAV) that may utilize battery power as a flight power source. The aircraft may be used for various purposes, including military, cargo transport, agricultural, firefighting, and search and rescue operations, and may also be used to monitor eco-friendly energy facilities (such as wind power generation and solar power generation).

An aircraft according to the disclosure provides the advantage of being self-powered through wind power, eliminating the need for separate charging devices and equipment for aircraft charging, thereby minimizing associated costs. Furthermore, the aircraft does not require battery replacement, reducing the amount of human input required for aircraft operation. Furthermore, the aircraft and landing pad according to the disclosure may be applied to green technology fields utilizing eco-friendly energy.

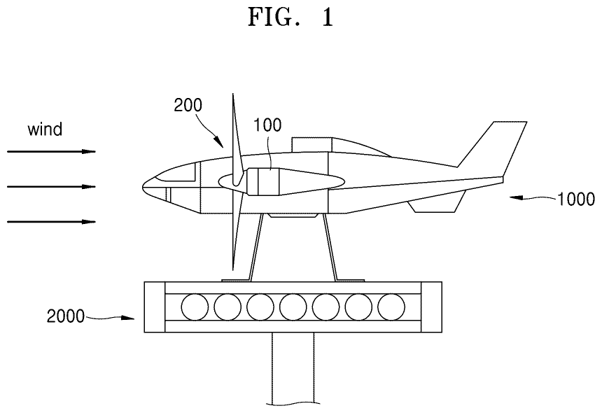

Hereinafter, an example of the aircraft and the landing pad according to an embodiment will be described with reference to FIG. 1. FIG. 1 shows a schematic diagram of a landing pad 2000 and an aircraft 1000 according to an embodiment.

As shown in FIG. 1, the aircraft 1000 may land on the landing pad 2000. While landing on the landing pad 2000, the aircraft 1000 may maintain either a wind power generation mode or a standby mode in which wind power generation is not performed.

For example, when the aircraft 1000 has completed landing on the landing pad 2000, if the state of charge (SOC) of the aircraft 1000 is below a predetermined value, the aircraft 1000 may be set to a power generation mode to charge the battery of the aircraft 1000 using wind energy. Alternatively, if the battery state of charge is above a predetermined value or if wind power is insufficient to generate wind power, the aircraft 1000 may be set in a standby mode.

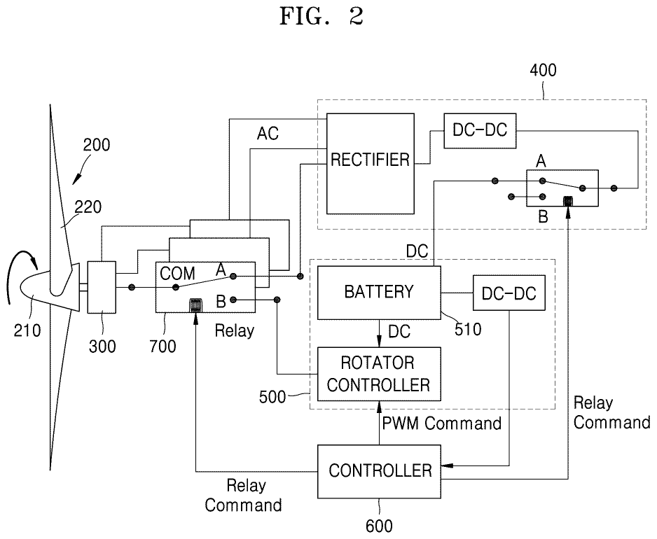

The landing pad 2000 may be mounted together with the wind power generator or may be individually installed at appropriate distances, considering the operational range of the aircraft 1000. The landing pad 2000 will be described below, and the aircraft 1000 will be described with reference to FIG. 2.

FIG. 2 is a schematic diagram illustrating a rotor 200 of the aircraft and a circuit diagram thereof.

According to an embodiment, the aircraft 1000 may include a nacelle 100 equipped with the rotor 200, a rotator 300 connected to the rotor 200 and capable of converting the rotational energy of the rotor 200 into electrical energy, and a power generation module 400 that charges a battery with the electrical energy of the rotator 300. The rotor 200 is configured to freely rotate by wind power when the aircraft 1000 is not flying.

Additionally, the aircraft 1000 may further include a drive module 500 that provides power from a battery 510 to the rotator 300, and the drive module 500 may provide power from the battery 510 to the rotator 300 during the flight of the aircraft 1000, thereby rotating the rotator 300 and the rotor 200. The nacelle 100 may accommodate the aforementioned power generation module 400 and drive module 500, and may further accommodate a brake, a gear box, a control device, and the like.

Hereinafter, the rotor 200 and the rotator 300 will be described.

The rotor 200 and the rotator 300 may be connected via a gear box (not shown). The gear box may control the rotation speed of the rotor 200 when transmitting the rotation of the rotor 200 to the rotator 300 to change the low-speed rotation of the rotor 200 into high-speed rotation, and allows the rotator 300 to rotate at a constant speed through the speed change.

The rotor 200 may include a hub 210, a plurality of blades 220 hinged to the hub 210, and a pitch actuator 250 for adjusting the pitch angle of the blades 220.

The blades 220 may rotate about the hub 210 as a central axis when subjected to wind, and the rotator 300 is connected to the hub 210 so that the rotator 300 rotates as the rotor 200 rotates.

The blade 220 is hinge-connected to the hub 210 so that a pitch angle of the blade 220 is adjusted, and the pitch angle of the blade 220 may be adjusted to a predetermined angle through the pitch actuator 250. The plurality of blades 220 may be controlled using a collective pitch control method in which the pitch angles are adjusted simultaneously. The pitch angle of the blade 220 may be controlled to control the rotational speed of the rotor 200 within a target rotational speed range, and the control of the pitch angle will be described later.

The rotator 300 may function as an electric motor that receives power from a battery and converts electrical energy into mechanical energy when the aircraft 1000 flight mode. When the aircraft 1000 is in a power generation mode, the rotator 300 may function as a generator that converts mechanical energy generated by the rotation of the rotor 200 into electrical energy.

Specifically, the aircraft 1000 according to an embodiment may further include a relay element 700 and a controller 600 for controlling the relay element. The controller 600 may determine, through controlling of the relay element 700, whether the rotator 300 will function as an electric motor or a generator.

The relay element 700 may include a contact point A electrically connected to the power generation module 400 and a contact point B electrically connected to the drive module 500, and a contact point COM electrically connected to the rotator 300. The controller 600 may transmit a control signal so that the contact point COM is connected to the contact point A when the aircraft is not flying, and may transmit a control signal so that the contact point COM is connected to the contact point B when the aircraft is flying.

In a state that the relay element 700 is connected to the contact point A, the rotor 200 may freely rotate due to wind power, and the rotator 300 may convert the rotational energy of the rotor 200 into electrical energy. The electrical energy may be connected to the charging unit of the battery 510 via the power generation module 400 and used as a charging power source for the battery 510.

The power generation module 400 may include a rectifier that converts the alternating current AC of the rotator 300 into direct current DC, a DC-DC converter that converts the DC power into DC power of a different predetermined voltage level, and a relay element that controls the electrical connection to the charging unit of the battery 510. The relay element of the power generation module 400 may control the electrical connection between the power generation module 400 and the charging unit of the battery 510 by performing a relay operation according to a command value of the controller 600.

While the relay element 700 is connected to the contact point B, the battery 510 supplies power to the rotator 300 through the drive module 500 to rotate the rotator 300, and thus, the rotor 200 rotates together to enable the flight of the aircraft 1000.

The drive module 500 may further include a rotator controller that controls the rotation speed of the rotator 300. The controller 600 generates a PWM signal and transmits the PWM signal to the rotator controller, and the rotator controller may control the rotation speed of the rotator 300 through the PWM signal. In addition, the drive module 500 may further include a DC-DC converter for converting the output voltage of the battery 510 into a voltage required by the controller 600, various actuators, sensors, etc. In FIG. 2, as an example, the DC-DC converter is shown as being connected to the controller 600 to convert the output voltage of the battery 510 into a required voltage of the controller 600, but is not limited thereto and may be additionally installed at an appropriate location as needed.

As described above, the aircraft 1000 according to an embodiment may provide the advantages of being environmentally friendly and economical because the aircraft 1000 may self-generate power through wind power and may charge its battery without an external charging device.

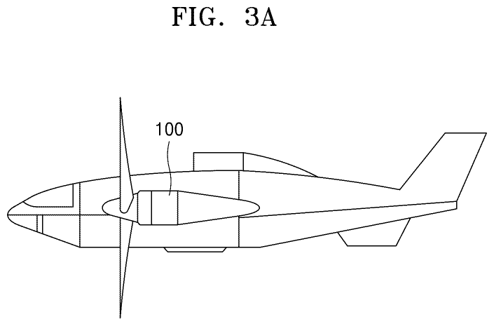

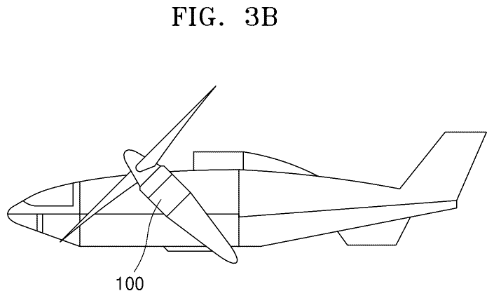

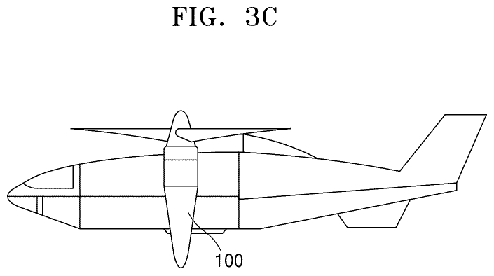

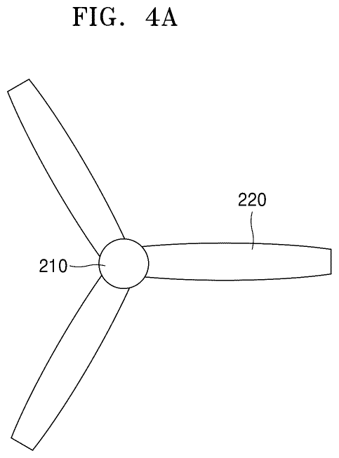

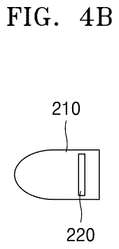

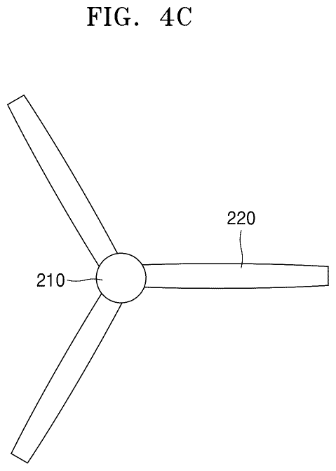

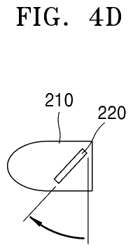

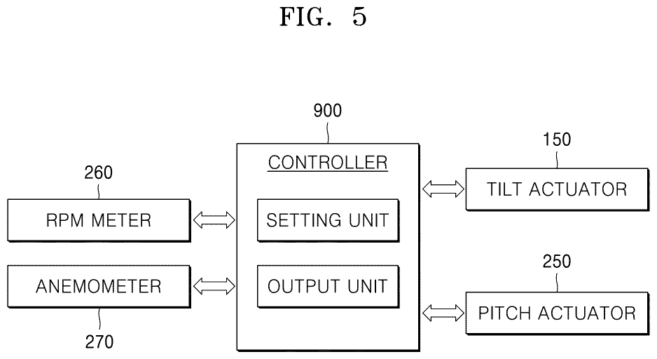

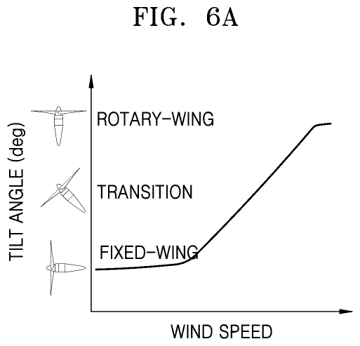

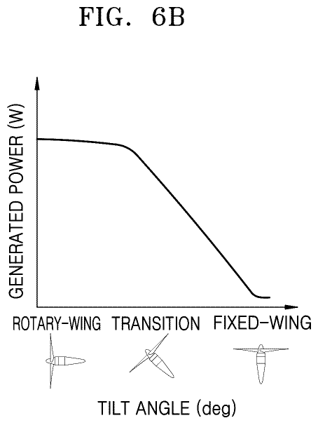

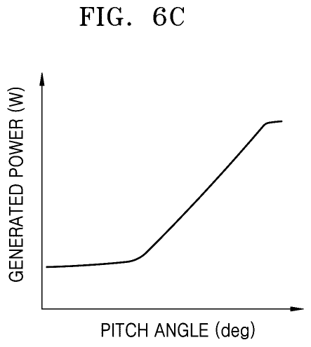

Hereinafter, a tilt angle of the nacelle 100 and the pitch angle of a blade 220 of the aircraft 1000 according to an embodiment will be described with reference to FIGS. 3A to 6C. FIGS. 3A to 3C illustrate the adjustment of the tilt angle of the nacelle 100, FIGS. 4A to 4D illustrate the adjustment of the pitch angle of the blade 220, FIG. 5 is a block diagram of a controller according to an embodiment, and FIGS. 6A to 6C are graphs illustrating the relationship between wind speed and tilt angle and the relationship between generated power according to the tilt angle and the pitch angle.

FIG. 3A illustrates a fixed-wing state in which the tilt angle of the nacelle 100 is 0°, FIG. 3B illustrates a transition state in which the tilt angle of the nacelle 100 is 45°, and FIG. 3C illustrates a rotary-wing state in which the tilt angle of the nacelle 100 is 90°. As such, the nacelle 100 of the aircraft 1000 according to an embodiment is configured to be tiltable from the aircraft, and the aircraft 1000 may further include a tilt actuator 150 for tilting the nacelle 100.

FIGS. 4A and 4B illustrate a state in which the pitch angle of the blade 220 is 0°, and FIGS. 4C and 4D illustrate a state in which the pitch angle increases by 30° in a direction of the arrow from the state in which the pitch angle is 0°. According to an embodiment, the rotor 200 may include the hub 210 and the plurality of blades 220 hinge-connected to the hub 210, and may further include the pitch actuator 250 for adjusting the pitch angle of the blades 220.

The tilt actuator 150 and the pitch actuator 250 described above may be controlled by a controller 900, and the controller 900 may include a setting unit that sets a target tilt angle of the nacelle 100 and a target pitch angle of the blade 220, and an output unit that outputs a first control signal that instructs the operation of the tilt actuator 150 to control the nacelle 100 to the target tilt angle, and a second control signal that instructs the operation of the pitch actuator 250 to control the blade 220 to the target pitch angle.

FIG. 6A is a graph showing the relationship between increasing tilt angle and increasing wind speed, FIG. 6B is a graph showing the relationship between decreasing generated power and increasing tilt angle, and FIG. 6C is a graph showing the relationship in which generated power increases as the pitch angle of the blade 220 increases in a fixed-wing state in which the tilt angle of the nacelle 100 is 0°.

According to an embodiment, the controller 900 increases the pitch angle (increasing air resistance) when the wind speed increases based on the measurement value of the rpm meter 260, which will be described later, and decreases the pitch angle (decreasing air resistance) when the wind speed decreases, thereby allowing the rotor 200 and blades 220 to maintain a constant rotational speed. That is, by maintaining a constant rotational speed, the output voltage value is kept constant while only the current value is varied, and thus, the total output power may increase or decrease.

Specifically, as shown in the graph of FIG. 6A, in order to maintain a constant rotational speed of the rotor 200 and the blade 220, the tilt angle of the nacelle 100 is gradually increased as the wind speed continues to increase. If the wind speed exceeds a threshold value, the operation may be stopped by maximally tilting the tilt angle of the nacelle 100 (rotary-wing state with a tilt angle of 90°).

Also, it may be confirmed that, when the pitch angle is constant, as shown in the graph of FIG. 6B, when the tilt angle of the nacelle 100 is minimum (fixed-wing state with a tilt angle of 0°), the rotational speed of the rotor 200 is the fastest, resulting in the highest generated power, and as the tilt angle of the nacelle 100 gradually increases, the rotational speed of the rotor 200 is slow, resulting in lower generated power. Furthermore, when the tilt angle is constant, as shown in the graph of FIG. 6C, it may be seen that the generated power increases as the pitch angle increases.

The aircraft 1000 according to an embodiment may further include an rpm meter 260 for measuring the rpm of the rotor 200. The setting unit of the controller 900 may increase a target pitch angle or a target tilt angle if the measured value of the rpm meter 260 is greater than or equal to a reference value. The output unit may output a first control signal for controlling the pitch actuator and a second control signal for controlling the tilt actuator so that the pitch angle and the tilt angle approach the target pitch angle and the target tilt angle, respectively.

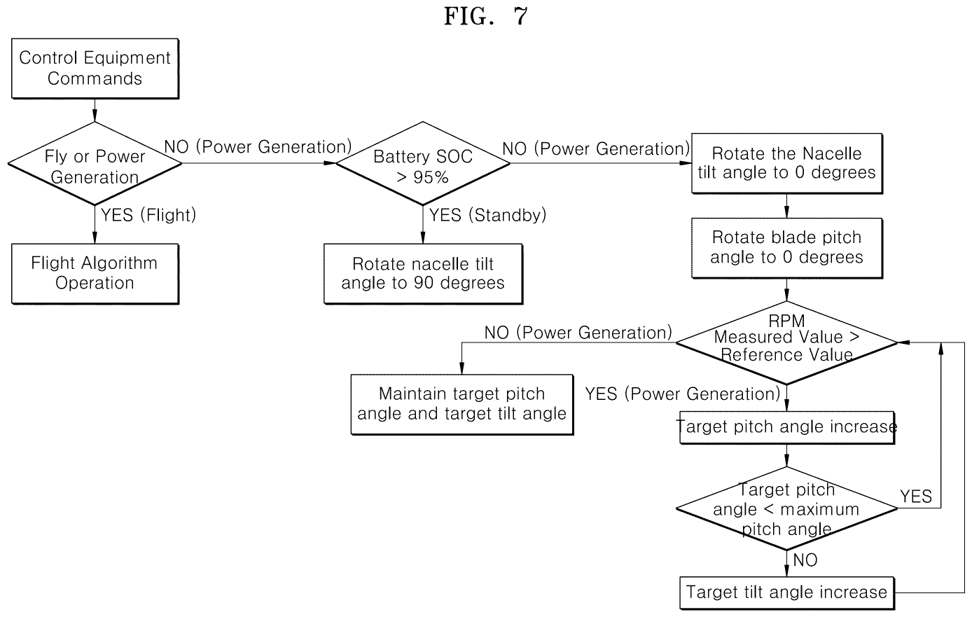

Specifically, if the measured value of the rpm meter 260 is greater than or equal to the reference value, the setting unit may increase the target pitch angle until the measured value of the rpm meter 260 falls below the reference value. Here, the reference value may be within ±10% of the target rotational speed, within ±5% of the target rotational speed, or within ±2% of the target rotational speed. The target pitch angle may only be increased up to the maximum pitch angle stored in the setting unit, and the setting unit may only increase the target tilt angle if the measurement value of the rpm meter 260 is still higher than the reference value even after increasing the target pitch angle up to the maximum pitch angle. FIG. 7 is a flowchart illustrating a method of adjusting a pitch angle and a tilt angle.

According to another embodiment, the aircraft 1000 allows the controller 900 to set a target pitch angle and a tilt angle based on a pre-stored data map. The data map may include data on the target pitch angle and the tilt angle corresponding to the current wind speed. The aircraft 1000 may further include an anemometer 270 capable of measuring wind speed, and wind speed data from the anemometer 270 may be transmitted to the controller 900.

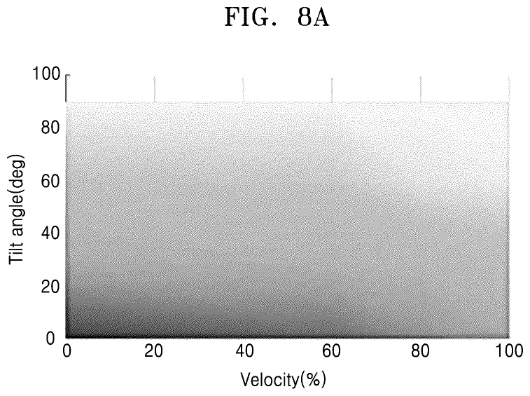

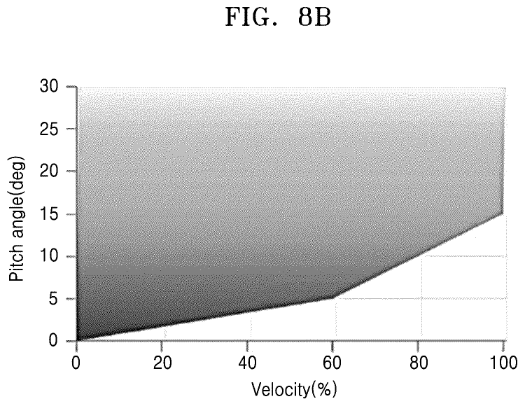

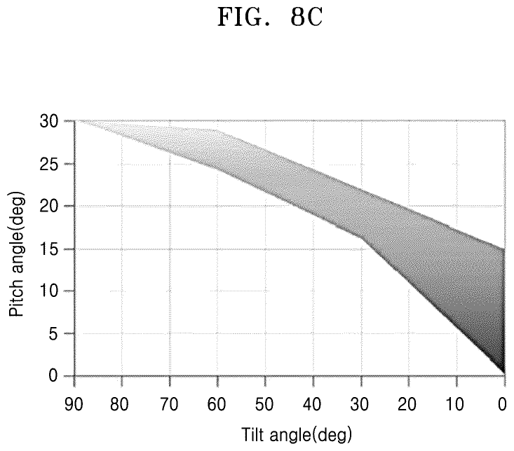

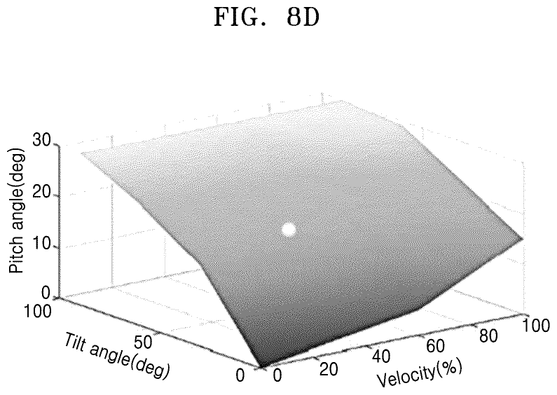

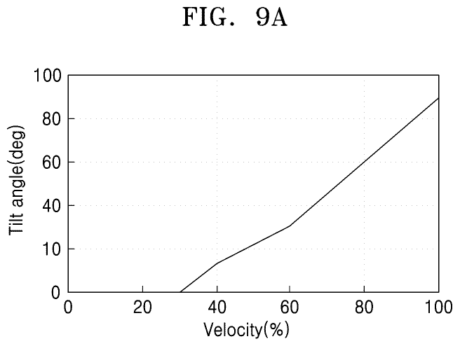

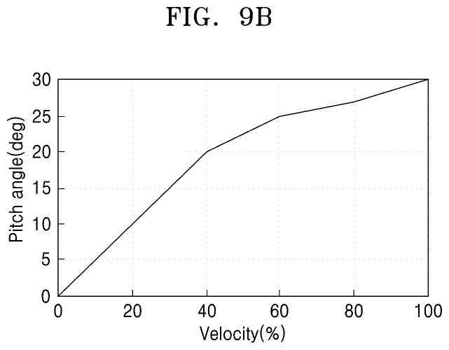

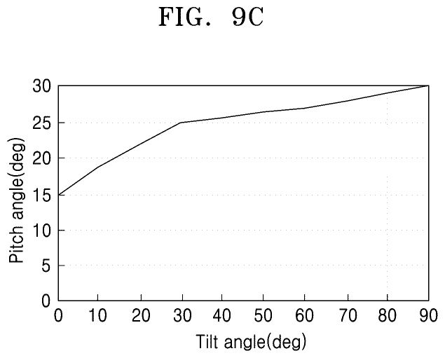

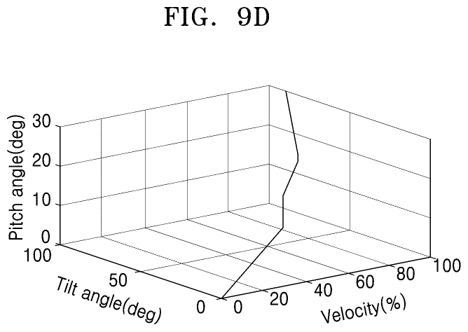

FIGS. 8A to 9D illustrate examples of pre-stored data maps. FIGS. 8A to 8D illustrate that the pre-stored data map is a three-dimensional data map, while FIGS. 9A to 9D illustrate that the pre-stored data map is a two-dimensional data line.

As shown in FIGS. 8A to 8D, the target pitch and tilt angles may be set using a 3D data map where the pitch and tilt angles change in relation to wind speed changes. In the data maps of FIGS. 8A to 9D, wind speed (velocity) is expressed as 0% to 100% relative to the maximum wind speed, which is used in the same sense as expressing engine throttle as 0% to 100%.

Below, a detailed method of controlling the nacelle 100 and blades 220 is described. However, these are examples and do not necessarily denote fixed values.
A) When power generation is required on an aircraft based on a control equipment command (e.g., a controller), the nacelle tilt angle of the aircraft is maintained at 0° (fixed-wing shape).
B) Starts tilt Angle 0°: the pitch angle at 0° and is maintained to rotate within ±2% of the target rotor speed (e.g., 1,000 rpm). To maintain the rpm, a logic (such as PID control) may be applied to control the target pitch angle by fine increases/decrease of ±1° by receiving feedback on the rpm values measured across the entire tilt angle range (0° to 90°).
B- 1) If the wind speed is low and the rotor rpm at a pitch angle of 0° is less than the target rpm, power generation is halted.
B- 2) If the wind speed is high and the rotor rpm at a pitch angle of 0° is greater than the target rpm, the target pitch angle is slowly increased to 15°, and the blade pitch angle is increased so that the rotor speed approaches the target rpm.
C) If the wind speed continues to increase and the pitch angle reaches 15°, the target tilt angle of the nacelle is slowly increased up to 30° while the target pitch angle is gradually increased from 15° to 16° in increments of 1/30° to verify whether the target rotational speed is maintained. If the target rotational speed is maintained, the increase in the target tilt angle is stopped and maintains the corresponding tilt angle.
D) If the target rotational speed is not maintained at a tilt angle of 30°, only the target pitch angle is increased from 16° to 22°. Thereafter, if the wind speed continues to increase, the target pitch angle is gradually increased from 22° to 24° in an increment of 1/30°, while the target tilt angle of the nacelle is slowly increased up to 60°, and verifies whether the target rotational speed is maintained.
E) If the target rotational speed is not maintained at a tilt angle of 60°, only the target pitch angle is increased from 24° to 29°, and if the wind speed continues to increase, the target pitch angle is slowly increased from 29° to 30° in an increment of 1/30° while slowly increasing the target tilt angle of the nacelle to 90° and check if the target rotational speed is maintained.

As described above with reference to FIGS. 8A to 8D, according to an embodiment, the controller 900 may increase the target tilt angle and target pitch angle along a predetermined data line according to the wind speed, as shown in FIGS. 9A to 9D.

In this way, the setting unit of the controller 900 may schedule the pitch angle of the blade 220 and the tilt angle of the nacelle 100 according to the current wind speed, and thus, the aircraft 1000 has the advantage of being able to generate power optimized for the current wind speed.

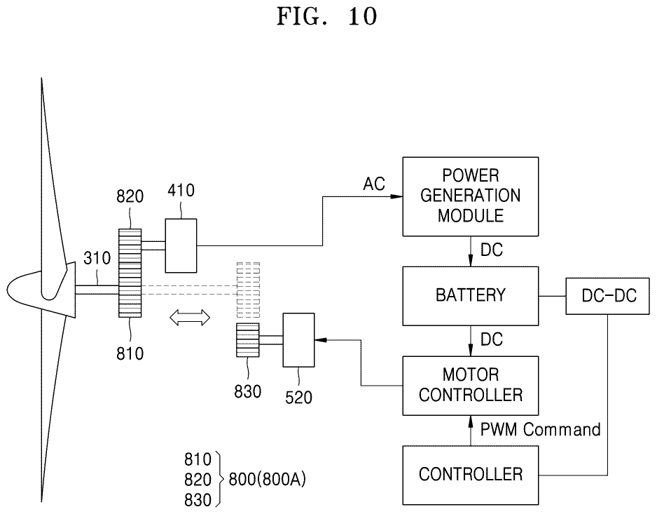

Hereinafter, the structure of the aircraft 1000 according to the present disclosure will be described with reference to FIGS. 10 and 11. FIGS. 10 and 11 are block diagrams illustrating the structure of the aircraft 1000 according to an embodiment.

According to an embodiment, the power generation module 400 includes a power generation motor 410, the drive module 500 includes a flight motor 520, and may further include a switching module 800 that mechanically connects the rotor with either the power generation motor 410 or the flight motor 520. The power generation motor 410 or flight motor 520 may correspond to a BLDC motor.

The flight motor 520 is driven by battery power to rotate the rotator 300 and the rotor 200, and its speed is controlled by a motor controller.

An example of a switching module 800A will be described with reference to FIG. 10. The switching module 800A may include a gearbox and an actuator. The gearbox may include a first gear 810 fitted to a rotational axis 310 of the rotor, a second gear 820 fitted to the rotational shaft of the power generation motor 410, and a third gear 830 fitted to the rotational shaft of the flight motor 520. Here, the rotational axis 310 of the rotary machine is configured to have a variable length, and the actuator may change the length of the rotational axis 310 of the rotary machine so that the first gear 810 and the second gear 820 mesh with each other, or the first gear 810 and the third gear 830 mesh with each other.

That is, if the first gear 810 and the second gear 820 are engaged, it may correspond to the power generation mode, and if the first gear 810 and the third gear 830 are engaged, it may correspond to a flight mode.

Another example of a switching module 800B will be described with reference to FIG. 11. The switching module 800B may include a clutch 840 connected to a gearbox, an actuator, and a flight motor 520. The gearbox includes a first gear 810 fitted to the rotational shaft of the rotor, and a second gear 820 fitted to the rotational shaft of the power generation motor 410. The actuator moves the second gear 820 to engage or disengage the first gear 810 and the second gear 820, and the clutch 840 may transmit or block power of the flight motor 520 to the rotor 200.

That is, when the first gear 810 and the second gear 820 are misaligned and the clutch 840 transmits the power of the flight motor 520 to the rotor 200, the aircraft is in a flight mode, and when the first gear 810 and the second gear 820 are engaged and the clutch 840 blocks the power transmission between the flight motor 520 and the rotor 200, the aircraft may be in a power generation mode.

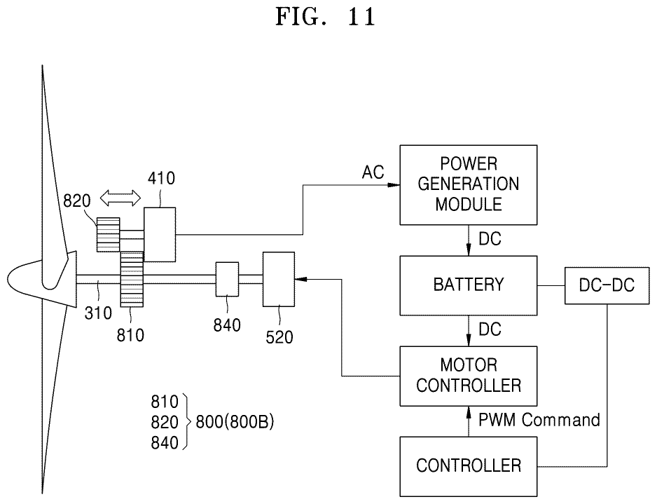

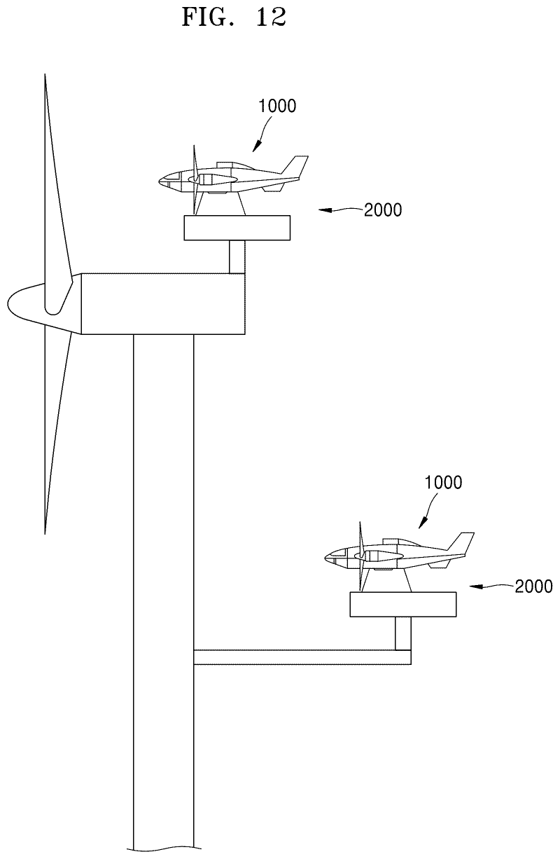

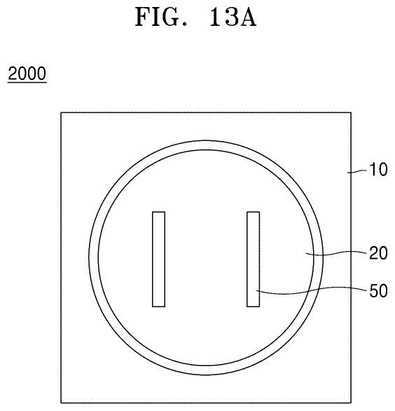

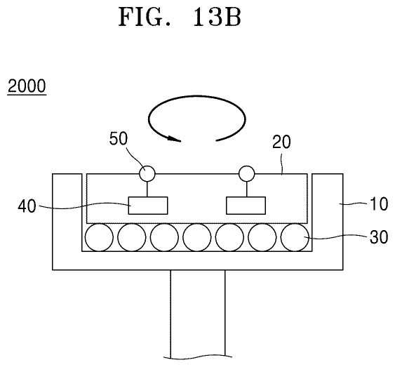

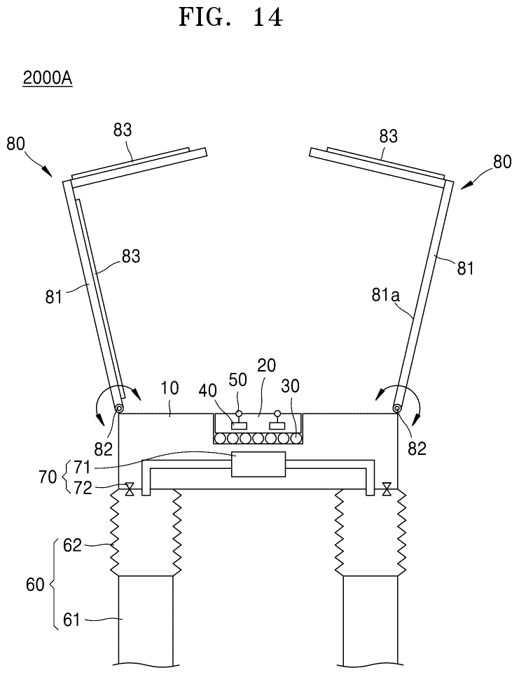

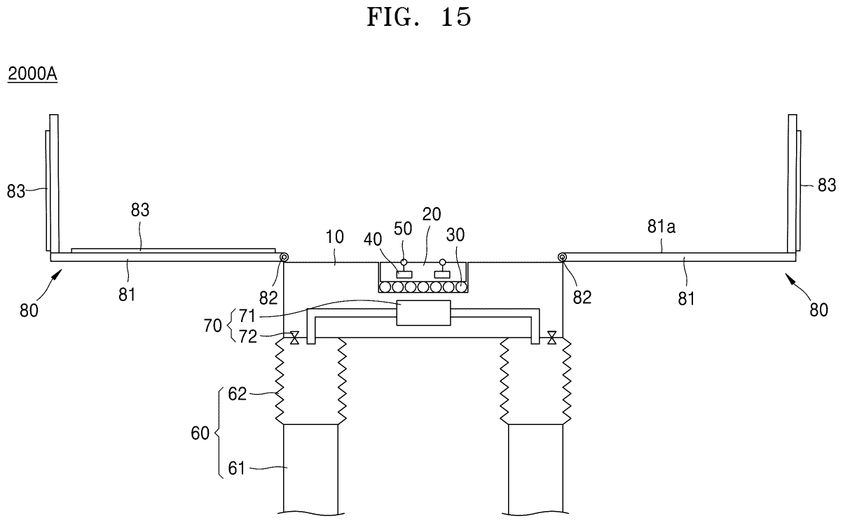

The aircraft 1000 has been described above, and the landing pad 2000 and 2000A will be described below with reference to FIGS. 12 to 15. FIG. 12 shows an example in which a plurality of landing pads 2000 are installed on a wind turbine, FIGS. 13A and 13B show schematic diagrams of landing pads, FIG. 14 shows a landing pad according to another example of the disclosure, and FIG. 15 shows a state in which a protective cover is fixed at a specific angle.

As described above, the landing pad 2000, as shown in FIG. 12, may be mounted on a wind turbine or individually installed at appropriate distances considering the operational range of the aircraft 1000. According to an embodiment, the aircraft 1000 may fly while moving between multiple landing pads, enabling wide-area monitoring with a small number of aircraft, thereby increasing operational efficiency of the aircraft, and the ability to monitor a wide area provides the advantage of easy maintenance of the wide area.

In an embodiment, referring to FIGS. 13A and 13B, the landing pad 2000 may largely include a base 10 and a rotating landing plate 20 that may rotate from the base 10 and accommodate the aircraft 1000. The rotating landing plate 20 is configured to freely rotate according to the wind direction, so that the wind is incident parallel to the rotational axis of the rotor 200 of the aircraft 1000 that lands on the rotating landing plate 20.

The base 10 may be secured to the ground via a tower or the like, and a bearing 30 may be provided between the base 10 and the rotating landing plate 20, allowing the rotating landing plate 20 to rotate on the base 10. In this case, the bearing 30 may correspond to a thrust bearing.

The rotating landing plate 20 may be equipped with a fixing mechanism 50 that secures the aircraft 1000 to the rotating landing plate 20. The fixing mechanism 50 may correspond to, for example, a clamp, a gripper, or the like, and the fixing mechanism 50 secures at least a portion of the aircraft (such as the landing gear) to the rotating landing plate 20. The fixing mechanism 50 may secure at least a portion of the aircraft to the rotating landing plate 20 according to the operation of the servo motor 40.

By fixing the aircraft to the rotating landing plate 20 by the fixing mechanism 50, the aircraft and the rotating landing plate 20 may only rotate in accordance with the wind direction even when the wind blows, and horizontal movement is impossible. In other words, the landing pad 2000 according to an embodiment not only firmly secures the aircraft 1000 but also adjusts the aircraft's direction to match the wind direction, enabling the aircraft to generate optimal wind power.

Referring again to FIG. 12, when the landing pad 2000 is installed in the nacelle 100 of a wind turbine, the landing pad 2000 may rotate along with the rotation of the wind turbine of the nacelle 100. In this case, because the aircraft's direction may be adjusted to match the wind direction simply by rotating the nacelle 100 of a wind generator, it is also possible to provide a brake, etc., to limit the rotation of the bearing 30 while the rotating landing plate 20 remains parallel to the nacelle 100 of the wind generator.

In another embodiment, referring to FIG. 14, the landing pad 2000A may include a base 10, a rotating landing plate 20, a bearing 30, a servo motor 40, a fixing mechanism 50, a column 60, a column height adjustment unit 70, and a protective cover 80. Because the base 10, the rotating landing plate 20, the bearing 30, the servo motor 40, and the fixing mechanism 50 are identical or similar to those of the aforementioned landing pad 2000A, a detailed description thereof are omitted, and the differences will be mainly described.

The column 60 can support the base 10. There may be at least one column 60. In an embodiment, as illustrated in FIG. 14, there may be two columns 60. The column 60 may include a column body 61 and a length extension unit 62.

The length extension unit 62 may be capable of extending or retracting in the longitudinal direction of the column body 61. The length extension unit 62 may be hollow. The length extension unit 62 may be extended in the longitudinal direction of the column body 61 by injecting fluid into an interior of the hollow. The length extension unit 62 may be contracted in the longitudinal direction of the column body 61 by removing fluid from the interior of the hollow.

The column height adjustment unit 70 may adjust the length of the column 60 by injecting or removing fluid into the interior of the column 60. The column height adjustment unit 70 may include a fluid injection unit 71 and a fluid removal unit 72.

The fluid injection unit 71 may inject fluid into the interior of the column 60, i.e., into the interior of the aforementioned length extension unit 62. Thereby, the length of the column 60 may be extended. The fluid is not particularly limited. In an embodiment, the fluid may include external air. In an embodiment, the fluid injection unit 71 may include a pump.

The fluid removal unit 72 may remove fluid from the interior of the column 60, i.e., from the interior of the aforementioned length extension unit 62. Thereby, the length of the column 60 may be contracted. In an embodiment, the fluid removal unit 72 may include a valve.

Because the height of the column 60 may be adjusted using the column height adjustment unit 70, the aircraft 1000 may be positioned at a height that may obtain the optimal amount of power generation. Furthermore, it is possible to minimize interference caused by the wake of the wind turbine blades and may protect the aircraft 1000 from waves on a sea surface.

The protective cover 80 may be connected to one end of the base 10. The protective cover 80 may be rotatable. There may be at least one protective cover 80. In an embodiment, there may be two protective covers 80, as shown in FIG. 14. The protective cover 80 may include a cover body 81, a joint 82, and a solar power generation unit 83.

The joint 82 may connect the base 10 and the cover body 81. The cover body 81 may rotate around the joint 82. The cover body 81 may be fixed at a specific angle. In an embodiment, the cover body 81 may be fixed at an angle as shown in FIG. 14 to protect the aircraft 1000. In another embodiment, the cover body 81 may be fixed at an angle as shown in FIG. 15 to allow one surface 81a of the cover body 81 to be utilized as an additional activity space.

A solar power generation unit 83 may be fixed to a portion of the surface of the cover body 81. Accordingly, the landing pad 2000A itself may also generate electrical power. In an embodiment, the landing pad 2000A may further include a power storage unit (not shown) capable of storing the electrical power generated by the solar power generation unit 83.

While the embodiments of the disclosure have been described with reference to the accompanied drawings, those skilled in the art will understand that the present disclosure may be implemented in other specific forms without altering the technical spirit or essential features thereof. Therefore, the embodiments described above should be understood as illustrative in all respects and not limiting.

According to an embodiment, a separate charging device and charging equipment for charging the battery of a craft are unnecessary, thereby minimizing related costs.

Also, a battery replacement work of a worker is unnecessary, and thus, the amount of manpower required for aircraft operation may be reduced.

The effects of the present disclosure are not limited to those described above, and other unmentioned effects will be readily apparent to those skilled in the art from this specification and the accompanying drawings.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An aircraft having a wind power generation function, the aircraft comprising:
a nacelle to which a rotor is mounted;
a rotator connected to the rotor and configured to rotate together with the rotor and convert rotational energy of the rotor into electrical energy; and
a power generation module configured to charge a battery using the electrical energy generated by the rotator,
wherein the rotor is configured to freely rotate by wind power when the aircraft is not in flight.

2. The aircraft of claim 1, further comprising:
a drive module configured to supply power from the battery to the rotator,
wherein the drive module is configured to drive the rotor by supplying power from the battery to the rotator during a flight state of the aircraft.

3. The aircraft of claim 2, further comprising:
a relay element and a controller configured to control the relay element,
wherein a contact point A of the relay element is connected to the driving module, and a contact point B of the relay element is connected to the power generation module, and
the controller is further configured to control the relay element to connect to the contact point A when the aircraft is not in flight and to connect to the contact point B when the aircraft is in flight.

4. The aircraft of claim 3, wherein
when the relay element is connected to the contact point A,
the power generation module converts the rotational energy of the rotator by free rotation of the rotor into electrical energy to charge the battery.

5. The aircraft of claim 1, wherein
the rotor includes a hub, a plurality of blades hinge-connected to the hub, and a pitch actuator configured to adjust a pitch angle of the blades, and
the nacelle is configured to be tiltable with respect to the aircraft and includes a tilt actuator for tilting the nacelle.

6. The aircraft of claim 5, further comprising:
a controller configured to control the tilt actuator and the pitch actuator,
wherein the controller comprises:
a setting unit configured to set a target tilt angle of the nacelle and a target pitch angle of the blade; and
an output unit configured to output a first control signal for controlling the operation of the tilt actuator to control the tilt angle of the nacelle to the target tilt angle and a second control signal for controlling the operation of the pitch actuator to control the pitch angle of the blade to the target pitch angle.

7. The aircraft of claim 6, further comprising:
an RPM meter configured to measure an RPM of the rotor,
wherein the setting unit is further configured to increase the target pitch angle or the target tilt angle when the measured value of the rpm meter is greater than or equal to a reference value.

8. The aircraft of claim 7, wherein
when the measured value of the rpm meter is greater than or equal to the reference value, the setting unit is further configured to increase the target pitch angle until the measured value of the rpm meter becomes less than the reference value.

9. The aircraft of claim 8, wherein
the setting unit is capable to increase the target pitch angle to a preset maximum pitch angle, and
the setting unit is further configured to increase the target tilt angle when the measured value of the rpm meter is greater than the reference value even when the target pitch angle increases up to the maximum pitch angle.

10. The aircraft of claim 6, wherein
the setting unit is further configured to set the target pitch angle and the target tilt angle according to a pre-stored data map,
wherein the data map includes data on the target pitch angle and the target tilt angle corresponding to a current wind speed.

11. The aircraft of claim 2, wherein
the power generation module includes a power generation motor,
the driving module includes a flight motor, and
the aircraft further includes a switching module that mechanically connects the rotator to either the power generation motor or the flight motor.

12. The aircraft of claim 11, wherein
the switching module includes a gearbox and an actuator,
wherein the gearbox includes a first gear fitted on the rotational axis of the rotator, a second gear fitted on the rotational axis of the power generation motor, and a third gear fitted on the rotational axis of the flight motor,
the rotational axis of the rotator is configured to have a variable length, and
the actuator is configured to vary a length of the rotational axis of the rotator so that the first gear and the second gear mesh with each other or the first gear and the third gear mesh with each other.

13. The aircraft of claim 11, wherein
the switching module includes a gearbox, an actuator, and a clutch connected to the power generation motor,
the gearbox includes a first gear fitted on the rotational axis of the rotor and a second gear fitted on the rotational axis of the power generation motor,
the actuator is configured to move the second gear to engage or disengage the first gear and the second gear, and
the clutch transmits or blocks power of the flight motor to the rotor.

14. A landing pad for landing of an aircraft according to any one of claims 1 to 13, the landing pad comprising:
a base; and
a rotating landing plate rotatable with respect to the base and configured to accommodate the aircraft,
wherein the rotating landing plate is further configured to freely rotate according to a wind direction.

15. The landing pad of claim 14, further including a bearing between the base and the rotating landing plate.

16. The landing pad of claim 14, further comprising:
a servo motor and a fixing mechanism for fixing the aircraft to the rotating landing plate,
wherein the fixing mechanism fixes at least a portion of the aircraft to the rotating landing plate according to an operation of the servo motor.

17. The landing pad of claim 14, further comprising:
at least one column supporting the base; and
a column height adjustment unit configured to adjust the length of the column by injecting or removing fluid into the interior of the column.

18. The landing pad of claim 14, further comprising:
at least one protective cover connected to one end of the base and rotatable.
